(19) United States
(12) Patent Application Publication
(10) Pub. No.: US 2016/0288138 A1
(43) Pub. Date: Oct. 6, 2016

(54) ELECTROSTATIC PRECIPITATOR STRUCTURE

(71) Applicant: National Chiao Tung University, Hsinchu City (TW)

(72) Inventor: Chuen-Jinn TSAI, Hsinchu City (TW)

(21) Appl. No.: 14/739,754

(22) Filed: Jun. 15, 2015

(30) Foreign Application Priority Data
Apr. 2, 2015 (TW) 104111038

(51) Int. Cl. B03C 3/47; B03C 3/49

(52) U.S. Cl. CPC B03C 3/47; B03C 3/49

(57) ABSTRACT

An electrostatic precipitator structure includes a dielectric plate arranged between two collecting electrode plates, which define an air flow channel. The dielectric plate divides the air flow channel into two sub-channels. A plurality of discharge wires are attached on in the upper and lower surfaces of the dielectric plate for generating corona discharge in the sub-channels. When a gas with particles passes through the sub-channels, the particles are charged by the ions produced by corona discharge and then migrate to the collecting electrode plates by electrostatic force. This electrostatic precipitator structure may avoid intensive particle contamination on the discharge wires, wherefore particle collection efficiency is enhanced. Further, due to the insulating dielectric plate immobilize the attached ions, the corona current and the ozone concentration is reduced, wherefore power efficiency is enhanced.

### BACKGROUND OF THE INVENTION

1. Field of the Invention

The present invention relates to an electrostatic precipitator structure, particularly to an electrostatic precipitator structure whose discharge wires are less likely to be contaminated by particles and whose dust collection efficiency is enhanced.

2. Description of the Prior Art

A common electrostatic precipitator device uses a high voltage power supply to generate corona discharge, and the corona discharge ionizes air molecules. Particles in the air are charged by the ionized air molecules. Thus, the charged particles migrate to dust collection plates. Thereby, particles are removed from the air stream, and the air is purified.

Referring to FIG. 1, in a conventional electrostatic precipitator structure 10, a plurality of discharge wires 12 are directly disposed between two collecting electrode plates 14, 14′. The discharge wires 12 generate corona discharge to make the particles in the air, which flows along an air flow direction A to pass through the space between two collecting electrode plates 14, 14′, be collected by the collecting electrode plate 14, 14′. However, the discharge wires 12 of the conventional electrostatic precipitator structure 10 are entirely directly exposed to the processed air. Then, the particles are likely to accumulate on the discharge wires 12. Thus, the electric field intensity and dust collection efficiency diminishes with the usage time. The contaminated discharge wires 12 need cleaning by rapping periodically. However, the discharge wires 12 are hard to clean. If the user intends to clean the discharge wires via injecting water, the electrostatic precipitator system must be turned off to avoid electric short-circuit to occur.

### SUMMARY OF THE INVENTION

One objective of the present invention is to provide an electrostatic precipitator structure whose discharge wires are placed on the surface of a dielectric member to prevent the discharge wires from being exposed to the particles of the processed air and prevent the discharge wires from being contaminated by the particles, whereby the dust collection efficiency of the dust precipitator structure is enhanced and the period of cleaning the discharge wires is prolonged, and the abovementioned problems are resolved.

Another objective of the present invention is to provide an electrostatic precipitator structure, wherein there is no need to remove all discharge wires separately at the time of wire cleaning. The wires can be removed altogether with the dielectric member on which the discharge wires are assembled, whereby the time to disassemble and reassemble the discharge wires is reduced.

A still another objective of the present invention is to provide an electrostatic precipitator structure, wherein the dielectric member is arranged between two collecting electrode plates to generate a dielectric-barrier-discharge effect to enhance the corona discharge effect, whereby the dust collection efficiency of the electrostatic precipitator structure is enhanced.

A further objective of the present invention is to provide an electrostatic precipitator structure, wherein the insulating dielectric member immobilize the attached ions, whereby the corona current and the ozone concentration is reduced, wherefore power efficiency is enhanced.

To achieve the abovementioned objectives, the present invention proposes an electrostatic precipitator structure, which includes at least two collecting electrode plates, at least one dielectric member and a plurality of discharge wires. The collecting electrode plates are arranged apart from each other. Each two adjacent collecting electrode plates define an air flow channel. The air flow channel has an inlet and an outlet, and the air to be processed enters the air flow channel from the inlet. The dielectric member is arranged in the air flow channel and separates the air flow channel into two sub-channels. The gas to be processed flows in the air flow channel along an air flow direction. The dielectric member has two opposite surfaces respectively facing the two collecting electrode plates. The discharge wires are attached on the surfaces of the dielectric member.

In one embodiment, the dielectric member is a dielectric plate parallel to the two collecting electrode plates. The dielectric plates and the collecting electrode plates are arranged alternately. The plurality of discharge wires is attached on the surface of the dielectric plate.

In one embodiment, each of the plurality of the discharge wires is arranged perpendicularly to the air flow direction at a fixed interval.

In one embodiment, the opposite inner surfaces of the two collecting electrode plates are hydrophobic surfaces. The two collecting electrode plates are grounded electrodes. The plurality of discharge wires is connected with a high-voltage power supply.

In one embodiment, a porous metallic plate is disposed at the inlet to straighten the gas flow to be processed.

In another embodiment, the electrostatic precipitator structure of the present invention includes a central dielectric member, a hollow cylindrical collecting electrode, and a plurality of discharge wires. The central dielectric member includes two opposite surfaces and a side surface. The hollow cylindrical collecting electrode encircles the periphery of the central dielectric member. The side surface of the central dielectric member and the hollow cylindrical collecting electrode jointly define an air flow channel where a gas to be processed flows along an air flow direction. The air flow channel includes an inlet and an outlet. The plurality of discharge wires is distributed on the side surface of the central dielectric member. One end of each discharge wire intersects at least one of the two surfaces of the central dielectric member.

In one embodiment, the central dielectric member is a cylindrical dielectric body; the central dielectric member and the hollow cylindrical collecting electrode are concentric but respectively have different diameters.

In one embodiment, a high-voltage power supply is connected with the discharge wires. Each of the discharge wires is attached on the side surface of the central dielectric member along the air flow direction.

In one embodiment, a porous metallic plate is disposed at the inlet to straighten the gas flow to be processed.

### BRIEF DESCRIPTION OF THE DRAWINGS

FIG. 1 is a diagram schematically showing a conventional electrostatic precipitator structure;

FIG. 2 is a diagram schematically showing an electrostatic precipitator structure according to one embodiment of the present invention;

FIG. 3 is a diagram schematically showing an application of the electrostatic precipitator structure according to one embodiment of the present invention;

FIG. 4 is a diagram schematically showing an electrostatic precipitator structure according to another embodiment of the present invention; and

FIG. 5 is a sectional view of the electrostatic precipitator structure shown in FIG. 4.

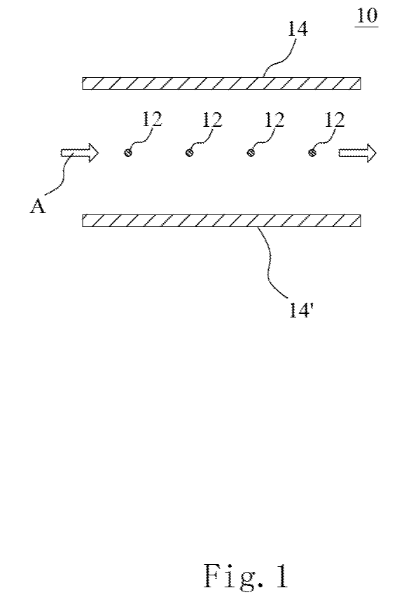

### DESCRIPTION OF THE PREFERRED EMBODIMENT

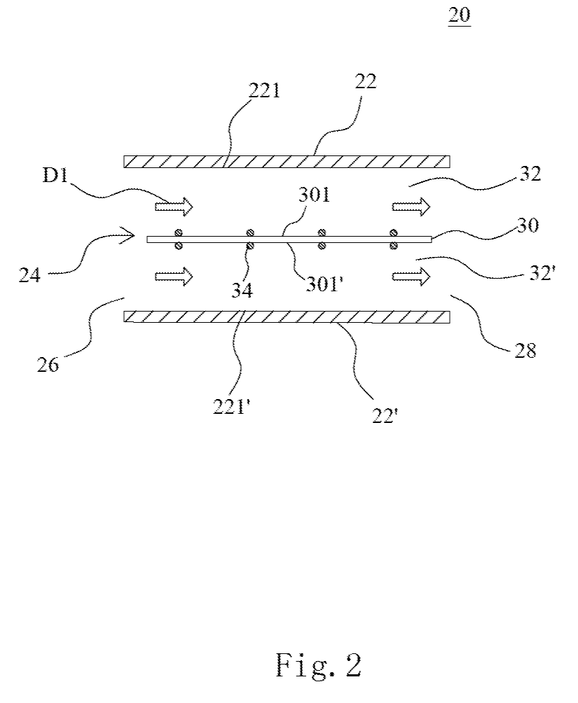

Refer to FIG. 2 a diagram schematically showing an electrostatic precipitator structure according to one embodiment of the present invention. The electrostatic precipitator structure 20 of the present invention includes at least two collecting electrode plates 22, 22′, a dielectric member 30, and a plurality of discharge wires 34. The collecting electrode plates 22, 22′ are arranged apart from each other. Each two adjacent collecting electrode plates 22, 22′ define an air flow channel 24. The collecting electrode plates 22, 22′ shown in FIG. 2 are arranged apart from each other and parallel to each other. The air flow channel 24 defined by two collecting electrode plates 22, 22′ has an inlet 26 and an outlet 28. The dielectric member 30 is arranged in the air flow channel 24 and separates the air flow channel 24 into two sub-channels 32, 32′. The gas to be processed flows in the air flow channel 24 along an air flow direction D1. In one embodiment, the dielectric member 30 is a dielectric plate; the dielectric plate is arranged parallel to the two collecting electrode plates 22, 22′; the dielectric plate and the collecting electrode plates 22, 22′ are arranged alternately. The dielectric member 30 has two opposite surfaces 301, 301′ respectively facing the two collecting electrode plates 22, 22′. The discharge wires 34 are attached on the two opposite surfaces 301, 301′ of the dielectric member 30. In one embodiment, each of the plurality of the discharge wires 34 is arranged perpendicularly to the air flow direction D1 at a fixed interval.

The dielectric member 30 is preferably configured in the middle of the air flow channel 24, whereby the two sub-channels 32, 32′ have a fixed width, as shown in FIG. 2. The discharge wires 34 are evenly distributed on the two surfaces 301, 301′ of the dielectric member 30. In one embodiment, the discharge wires 34 are arranged perpendicularly to the air flow direction D1. The electrostatic precipitator structure 20 further includes a porous metallic plate (not shown in the drawing) arranged at the inlet 26 to straighten the gas flow to be processed, before the gas to be processed enters the air flow channel 24. The straight gas flow enters the air flow channel 24 and then splits into two gas flows respectively entering the sub-channels 32, 32′.

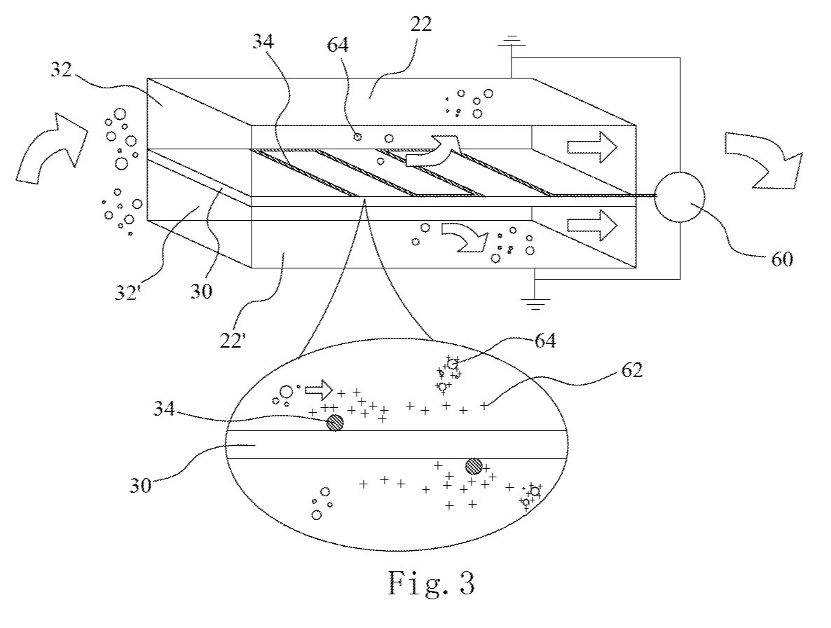

Refer to FIG. 3 a diagram schematically showing an application of the electrostatic precipitator structure according to one embodiment of the present invention. The two collecting electrode plates 22, 22′ are grounding electrodes. The discharge wires 34 are connected with a high-voltage power supply 60. While the high-voltage power supply 60 supplies power, the discharge wires 34 generate corona discharge. The ion clouds 62 of the corona discharge move toward the collecting electrode plates 22, 22′, which the discharge wires 34 face. The moving ion clouds 62 charge the particles 64 of the processed gas inside the sub-channels 32, 32′. The charged particles 64 are attracted toward the collecting electrode plates 22, 22′ by electrostatic force and collected by the collecting electrode plates 22, 22′. The dielectric member 30 arranged between the collecting electrode plates 22, 22′ enhances the corona discharge effect and inhibits glow discharge and filament discharge, whereby the dust collection efficiency of the electrostatic precipitator is increased. Further, the insulating dielectric member 30 immobilizes the attached ions, whereby the corona current is decreased and the power consumption is reduced.

As shown in FIG. 2, the discharge wires 34 are detachably attached on the surfaces 301, 301′ of the dielectric member 30. The design of attaching the discharge wires 34 on the dielectric member 30 makes only a portion of the surfaces of the discharge wires 34 exposed to the processed gas. Further, the electrostatic force surrounding the discharge wires 34 pushes the particles of the processed gas toward the collecting electrode plates 22, 22′ to prevent the discharge wires 34 from being contaminated by the particles, whereby the dust collection efficiency of the dust precipitator structure 20 is enhanced and the period of cleaning the discharge wires 34 is prolonged.

On the other hand, the particles collected by the collecting electrode plates 22, 22′ can be knocked off or removed via continuously injecting water. In one embodiment, the inner surfaces of the collecting electrode plates 22, 22′ are coated with a hydrophobic material to form hydrophobic surfaces, whereby the particles on the collecting electrode plates 22, 22′ can be more easily removed via injecting water.

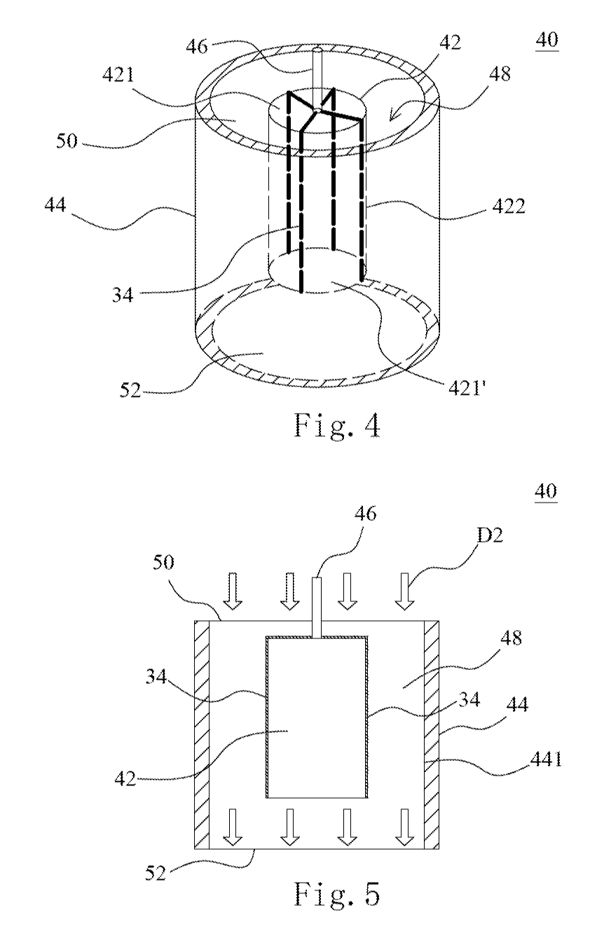

Refer to FIG. 4 and FIG. 5. FIG. 4 is a diagram schematically showing an electrostatic precipitator structure according to another embodiment of the present invention. FIG. 5 is a sectional view of the electrostatic precipitator structure shown in FIG. 4. In this embodiment, the electrostatic precipitator structure 40 of the present invention includes a central dielectric member 42, a hollow cylindrical collecting electrode 44 and a plurality of discharge wires 34. In one embodiment, the central dielectric member 42 is a cylindrical dielectric body having tow opposite surfaces 421, 421′ and a side surface 422. A high-voltage power supply 46 is arranged on the surface 421 of the central dielectric member 42. The hollow cylindrical collecting electrode 44 encircles the periphery of the side surface 422 of the central dielectric member 42. The side surface 422 of the central dielectric member 42 and the hollow cylindrical collecting electrode 44 jointly define an air flow channel 48. The processed gas flows in the air flow channel 48 along an air flow direction D2. The air flow channel 48 has an inlet 50 and an outlet 52. The discharge wires 34 are dispersively distributed on the side surface 422 of the central dielectric member 42 and the discharge wires 34 are connected with the high-voltage power supply 46.

In one embodiment, the central dielectric member 42 and the hollow cylindrical collecting electrode 44 are concentric but respectively have different diameters, whereby the central dielectric member 43 is located in the center of the hollow cylindrical collecting electrode 44, and whereby the air flow channel 48 between the central dielectric member 42 and the hollow cylindrical collecting electrode 44 has a fixed width, as shown in FIG. 4. In the same embodiment, the discharge wires 34 are evenly distributed on the side surface 422 of the central dielectric member 42, as shown in FIG. 4. In the embodiment shown in FIG. 4, the plurality of discharge wires 34 is exemplified by four pieces of discharge wires 34. However, the present invention does not limit that there must be four pieces of discharge wires 34 on the side surface 422. In one embodiment, the discharge wires 34 are attached on the side surface 422 of the central dielectric member 34 along the air flow direction D2. In one embodiment, the electrostatic precipitator structure 40 further includes a porous metallic plate (not shown in the drawing) arranged at the inlet 50 to straighten the gas flow to be processed; then the straight gas flow enters the air flow channel 48.

The hollow cylindrical collecting electrode 44 is a grounding electrode. While the high-voltage power supply supplies power, the discharge wires 34 generate corona discharge. The ion clouds of the corona discharge ionize the particles of the processed gas in the air flow channel 48. The charged particles are moved toward the hollow cylindrical collecting electrode 44 and collected by the hollow cylindrical collecting electrode 44. Further, the insulating central dielectric member 42 immobilizes the attached ions, whereby the corona current is decreased and the power consumption is reduced.

The particles collected by the hollow cylindrical collecting electrode 44 can be knocked off or removed via continuously injecting water. In one embodiment, an inner surface 441 of the hollow cylindrical collecting electrode 44, which faces the central dielectric member 42, is coated with a hydrophobic material to form a hydrophobic surface, whereby the particles on the hollow cylindrical collecting electrode 44 can be more easily removed via injecting water.

In the present invention, the discharge wires are attached on the dielectric member to prevent the discharge wires from being exposed to the particles of the processed gas and prevent the discharge wires from being contaminated by the particles. Thereby, the dust collection efficiency of the electrostatic precipitator structure is enhanced, and the period of cleaning the discharge wires is prolonged. Further, there is no need to remove all discharge wires separately at the time of wire cleaning. The discharge wires can be removed altogether with the dielectric member on which the discharge wires are assembled, whereby the time to disassemble and reassemble the discharge wires is reduced.

The embodiments have been described in detail to fully demonstrate the characteristics and spirit of the present invention. However, these embodiments are only to exemplify the present invention but not to limit the scope of the present invention. Contrarily, any equivalent modification or variation according to the characteristic or spirit of the present invention is to be also included within the scope of the present invention. The claims of the present invention should be interpreted in the broadest sense according to the specification and cover all possible equivalent modifications and variations.

What is claimed is:

1. An electrostatic precipitator structure comprising:
at least two collecting electrode plates arranged apart from each other, wherein each two said collecting electrode plates define an air flow channel having an inlet and an outlet, and wherein a gas to be processed enters said air flow channel through said inlet;
at least one dielectric member arranged inside said air flow channel, separating said air flow channel into two sub-channels, and having two surfaces opposite to each other, wherein said two surfaces respectively face said two collecting electrode plates, and wherein said gas to be processed flows inside said sub-channels along an air flow direction; and
a plurality of discharge wires respectively attached on said two surfaces of said dielectric member.

2. The electrostatic precipitator structure according to claim 1, wherein said dielectric member is a dielectric plate arranged parallel to said two collecting electrode plates, and wherein said dielectric member and said two collecting electrode plates are arranged alternately.

3. The electrostatic precipitator structure according to claim 1, wherein each of said discharge wires is arranged perpendicularly to the air flow direction at a fixed interval.

4. The electrostatic precipitator structure according to claim 1, wherein said discharge wires are attached on said two surfaces of said dielectric member.

5. The electrostatic precipitator structure according to claim 1, wherein each of said discharge wires is arranged perpendicularly to said air flow direction.

6. The electrostatic precipitator structure according to claim 1, wherein two opposite inner surfaces of said collecting electrode plates are hydrophobic surfaces.

7. The electrostatic precipitator structure according to claim 1, wherein said collecting electrode plates are grounding electrodes, and wherein said discharge wires are connected with a high-voltage power supply.

8. The electrostatic precipitator structure according to claim 1 further comprising a porous metallic plate arranged at said inlet for rearranging streamlines of said gas to be processed.

9. An electrostatic precipitator structure comprising:
a central dielectric member having two surfaces opposite to each other and a side surface;
a hollow cylindrical collecting electrode encircling a periphery of said side surface of said central dielectric member, wherein said side surface and said hollow cylindrical collecting electrode jointly define an air flow channel, and wherein said air flow channel has an inlet and an outlet, and wherein said gas to be processed flows inside said air flow channel along an air flow direction; and
a plurality of discharge wires dispersively distributed on said side surface of said central dielectric member, wherein ends of said discharge wires intersect on at least one of said two surfaces.

10. The electrostatic precipitator structure according to claim 9, wherein said central dielectric member is a cylindrical dielectric body, and wherein said central dielectric member and said hollow cylindrical collecting electrode are concentric but respectively have different diameters.

11. The electrostatic precipitator structure according to claim 9 further comprising a high-voltage power supply connected with said discharge wires.

12. The electrostatic precipitator structure according to claim 9, wherein each of said discharge wires is arranged on said side surface of said central dielectric member along said air flow direction.

13. The electrostatic precipitator structure according to claim 9, wherein an inner surface of said hollow cylindrical collecting electrode, which faces said central dielectric member, is a hydrophobic surface.

14. The electrostatic precipitator structure according to claim 9, wherein said discharge wires are attached on said side surface of said central dielectric member.

15. The electrostatic precipitator structure according to claim 9 further comprising a porous metallic plate arranged at said inlet for rearranging streamlines of said gas to be processed.
